(19) United States
(12) Patent Application Publication
(10) Pub. No.: US 2014/0014766 A1
(43) Pub. Date: Jan. 16, 2014

(54) Personal Aircraft

(71) Applicant: David C. Redmon, Fayetteville, NC (US)

(72) Inventor: David C. Redmon, Fayetteville, NC (US)

(21) Appl. No.: 13/943,328

(22) Filed: Jul. 16, 2013

Related U.S. Application Data
(60) Provisional application No. 61/672,022, filed on Jul. 16, 2012.

(51) Int. Cl. B64C 39/02

(52) U.S. Cl. CPC B64C 39/02
USPC 244/13

(57) ABSTRACT

A flying apparatus permitting a human operator to lie in a prone position to control the flying apparatus is disclosed. The flight and power controls can be manipulated by the operator's hands and feet, allowing the operator to take off, land, and perform aerobatic maneuvers while in a prone position. The human operator is securely maintained in a prone position through the use of a four-point strap harness and a roll cage or hatch that securely locks over the cockpit with the operator in place. The aircraft will be capable of takeoff and landing from almost any runway due to all-terrain landing gear attached to the airframe.

### CROSS-REFERENCE TO RELATED APPLICATION

This application claims the benefit of U.S. Provisional Application No. 61/672,022, filed Jul. 16, 2012; which is incorporated herein by reference in its entirety.

### BACKGROUND

As the popularity of flying in personal airframes grew during the late 1970s and early 1980s, mostly stimulated by the hang gliding movement, many flying aficionados sought affordable powered flight. Initial designs for such aircraft attached a small power plant to a hang glider wing, with the resulting aircraft controlled by the pilot's shifting of his/her weight to effect turns and other flying maneuvers. As designs became more sophisticated, seats, mechanical and electrical controls, flight control surfaces, and more energetic power plants were added to provide for greater control and better safety for pilots and passengers. Since the early 1980s, most ultralights have strut-braced wings and an airframe structure. Nearly all ultralights use 3-axis control systems, as used on standard airplanes, and these systems are the most popular. Flying such an ultralight, however, moves the pilot more and more away from an experience of freedom in flight and more to an experience of piloting a “plane,” in an upright and seated position. Although many pilots enjoy flying in almost any configuration, an ultralight flying apparatus has less mechanical structure than larger aircraft and may be considered to place a pilot closer to the experience of “flying like a bird.” As personal airframes continue to gain in popularity, the ease of use of smaller and less cumbersome structural configurations and different pilot configurations provide a closer experience to flying unfettered.

### SUMMARY

The presently disclosed subject matter generally relates to a flying apparatus that is configured to permit a person to lie prone in the fuselage of the flying apparatus and to control the flight surfaces using hand and foot controls.

In some aspects, the presently disclosed subject matter provides a flying apparatus for performing flight operations under control of a human operator, comprising: an airframe forming the body of the flying apparatus; a wing section having wing flap flight control surfaces; a tail section having rudder and tail flap flight control surfaces; a power plant and propeller sufficient to power the flying apparatus for all flight operations; a landing gear assembly supporting the airframe when not in flight; a cockpit and cockpit well extensions sufficient to permit a human operator to operate the flying apparatus in a prone position; and flying surface controls, power plant controls, and steering controls installed and configured to be manipulated when a human operator is in a prone position.

Certain aspects of the presently disclosed subject matter having been stated hereinabove, which are addressed in whole or in part by the presently disclosed subject matter, other aspects will become evident as the description proceeds when taken in connection with the accompanying Examples and Drawings as best described herein below.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a representative open cockpit view of the presently disclosed flying apparatus;

FIG. 2 illustrates a view of an operator fastened within the open cockpit of the presently disclosed flying apparatus;

FIG. 3 illustrates a side view of the presently disclosed flying apparatus with an operator in place and cockpit cover closed;

FIG. 4 illustrates a front view of the presently disclosed flying apparatus with an operator in place and cockpit cover closed;

FIG. 5 illustrates a top down view of the presently disclosed flying apparatus with an enclosed cockpit having an opening hatch with hinges;

FIG. 6 illustrates an expanded top down view of an enclosed cockpit;

FIG. 7 illustrates an expanded front view of an enclosed cockpit;

FIG. 8 illustrates a front view of the presently disclosed flying apparatus with an operator in place and an enclosed cockpit;

FIG. 9 illustrates a top down view of the presently disclosed flying apparatus with an operator in place and an enclosed cockpit; and

FIG. 10 illustrates a top down view of another embodiment of the presently disclosed flying apparatus with an operator in place and an enclosed cockpit.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

### I. Personal Aircraft

### A. Overview

Many governmental aviation authorities have established definitions of lightweight, slow-flying aircraft that could be subject to minimum regulations. In some instances, the resulting aircraft are commonly called “ultralight aircraft” or “microlights,” although the weight and speed limits differ from country to country. In other instances, the resulting aircraft are referred to as “sport-light” aircraft.

In some embodiments, the presently disclosed flying apparatus can be classified as an “ultralight” aircraft. In the United States, ultralight aircraft are regulated by 14 CFR Part 103, which defines an “ultralight” aircraft as a vehicle that: (a) is used or intended to be used for manned operation in the air by a single occupant; (b) is used or intended to be used for recreation or sport purposes only; (c) does not have any U.S. or foreign airworthiness certificate; and (d) if unpowered, weighs less than 155 pounds; or (e) if powered: (1) weighs less than 254 pounds empty weight, excluding floats and safety devices which are intended for deployment in a potentially catastrophic situation; (2) has a fuel capacity not exceeding 5 U.S. gallons; (3) is not capable of more than 55 knots calibrated airspeed at full power in level flight; and (4) has a power-off stall speed which does not exceed 24 knots calibrated airspeed. Accordingly, in some embodiments, the presently disclosed flying apparatus meets the criteria of an ultralight aircraft. For example, in some embodiments, the presently disclosed flying apparatus weighs less than 254 pounds empty weight, has a full capacity not exceeding 5 U.S. gallons, and is not capable of more than 55 knots calibrated airspeed at full power in level flight.

Other countries have differing definitions for such aircraft, but most definitions indicate aircraft typically having a takeoff weight between 650 pounds (for one person) and 1,300 pounds (for two people), and a stall speed in the 30 mph to 60 mph range. This definition forces the aircraft to be capable of a slow landing speed and short landing roll in the event of an engine failure.

In other embodiments, however, the presently disclosed flying apparatus does not meet the criteria of an ultralight aircraft. In such embodiments, for example, in which the cockpit is enclosed, the aircraft can weigh more than 254 pounds empty weight, have a full capacity exceeding 5 U.S. gallons, and/or is capable of more than 55 knots calibrated airspeed at full power in level flight.

In certain embodiments, the presently disclosed aircraft can be classified as a light-sport aircraft. The Federal Aviation Administration (FAA) defines a light-sport aircraft as an aircraft, other than a helicopter that meets the following criteria: maximum gross takeoff weight of 1,320 lbs (1,430 lbs for seaplanes); maximum stall speed of 51 mph (45 knots); maximum speed in level flight with maximum continuous power (VH) of 138 mph (120 knots); one or two person occupancy (pilot and one passenger); single, reciprocating engine (if powered); fixed or ground-adjustable propeller; an unpressurized cabin; and fixed landing gear, except for an aircraft intended for operation on water or a glider.

Light-sport aircraft can be manufactured and sold ready-to-fly under a Special Light-Sport Aircraft (S-LSA) certification category. To do so, the aircraft must meet industry consensus standards. Light-sport aircraft also can be licensed as Experimental Light-Sport Aircraft (E-LSA) if built from a kit or a plan.

### B. Representative Embodiments

Capturing the feeling of “flying like a bird” and providing a pilot with an aerobatic flying apparatus are two primary goals of the presently disclosed subject matter. The aircraft design disclosed herein will provide a pilot with the opportunity to perform almost any maneuver with the aircraft that he or she desires, thus meeting the goals for experiencing flight substantially the way a bird might experience flight, and providing a more fun and rewarding flying experience.

Generally, the presently disclosed flying apparatus includes an airframe comprising wing sections, a tail section, a power plant, and a propeller to establish and maintain flight. The wing section includes a cockpit area at the center point of the wing section sufficient to permit an operator, such as a pilot, to enter and lay in a prone position within the cockpit area. The cockpit has extensions into the wing sections on either side of the cockpit of sufficient size to accommodate the arms and hands of the operator and in which controls, such as wing flap controls, as well as a throttle and brake controls, are installed for operation as the operator lies prone in the cockpit area during flight operations. The wing section can include wings having a rectangular shape, an elliptical shape, a swept shape, or a delta shape, or any other wing shape suitable for use with the presently disclosed flying apparatus, depending on the flight characteristics desired for the presently disclosed flying apparatus.

The tail section includes rudder and tail flap control surfaces configured such that the operator can manipulate the rudder and tail flap, in some embodiments, using their feet to control the tail section control surfaces. A high performance power plant and propeller are disposed aft of the cockpit and tail section in a pusher style propulsion system.

The power plant can vary depending on desired characteristics of the user including, but not limited to, displacement, horsepower, airspeed, range, and weight. In some embodiments, the power plant can be selected from the group consisting of a 2-stroke engine, a 4-stroke engine, and an electric engine. Such engines can have one, two, three, four, or more cylinders and can be either air cooled or water cooled. Power plants suitable for use with the presently disclosed flying apparatus in the ultralight category can have a displacement from about 200 cubic centimeters (cm³ or cc) to about 1000 cc and a horsepower ranging from about 15 hp to about 100 hp.

Power plants suitable for use with the presently disclosed apparatus in the light-sport category can have a displacement from about 30 cubic inches to about 200 cubic inches; horsepower ranging from about 50 hp to about 120 hp; and an installed weight from about 100 pounds to about 280 pounds. The choice of power plant can dictate the classification of the aircraft. For example, the aircraft with one power plant might be classified as an ultralight aircraft, but might be classified as light-sport aircraft with a more powerful (and heavier) power plant.

All sections of the flying apparatus are operationally connected to the high performance airframe. An all-terrain fixed landing gear assembly can be attached to the underside of the airframe to support the weight of the flying apparatus and operator when on the ground. The construction of the airframe is of suitable materials and strength to maintain the integrity of the flying apparatus during aerobatic maneuvers as performed by the operator.

The safety of the operator of the flying apparatus is insured through means, for example, a 4-point harness, attached to the airframe that encloses the operator when the operator is inside the cockpit, and through an enclosure, such as a roll cage in some embodiments, that fastens, e.g., locks, over the pilot prior to takeoff. The operator is further supported while in the flying apparatus through pads upon which the operator will lay and which are movable as needed to conform to the operator's physical comfort needs. In other embodiments, the cockpit area is fully enclosed.

Accordingly, the presently disclosed subject matter provides a flying apparatus that is made in conformity with the specifications for an ultralight vehicle or sport-light aircraft in terms of weight and flying characteristics, but which provides an operator within the flying apparatus an experience that is highly aerobatic and more like what it might be like to fly like a bird. These goals are accomplished through the inclusion of hand controls sections that are embedded in wells within the wing sections of the flying apparatus, foot controls positioned at the distal portion of the fuselage near the tail section of the flying apparatus, and a cockpit in which the operator is placed in a prone position.

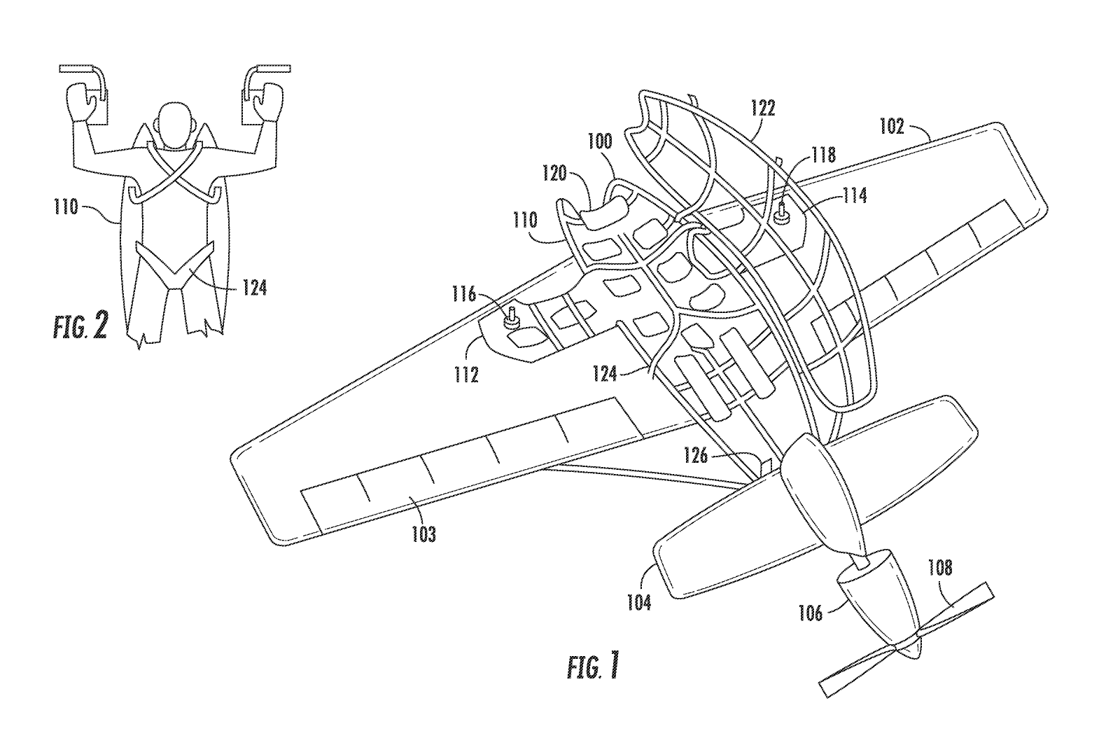

Referring now to FIG. 1, an exemplary view of the airframe and structural members of the flying apparatus with an open cockpit view is presented. In an exemplary embodiment, the flying apparatus is an apparatus capable of powered flight having an airframe 100 comprising wing section 102, wing flap flight control surfaces 103, tail section 104, power plant 106, and propeller 108 to establish and maintain flight. The airframe having cockpit area 110, in some embodiments, at the center point of wing section 102 sufficient to permit an operator, such as a pilot, to enter and lie in a prone position within cockpit area 110. The cockpit having extension wells 112, 114 formed into wing section 102 and extending from cockpit area 110 on either side of cockpit area 110 of sufficient size to accommodate the arms and hands of the operator and in which controls, such as means for controlling wing flap flight control surfaces 103, and throttle 116 and brake 118 are included. The relative positions of throttle 116 and brake 118 can be interchanged depending on operator preference. For example, throttle 116 can be positioned to be manipulated by an operator's right hand and brake 118 can be positioned to be manipulated by an operator's left hand and vice versa. In further embodiments, throttle 116 and brake 118 can be operated with the same hand, e.g., using a throttle and brake lever system similar to that of a motorcycle.

The operator lies prone in cockpit area 110 during flight operations with his/her arms inserted into extension wells 112, 114 to manipulate the controls installed in extension wells 112, 114. Flight controls for wing flap flight control surfaces 103 are installed in extension wells 112, 114 to permit the operator to adjust wing flap flight control surfaces 103 to control flight operations for takeoff, landing, and aerobatic maneuvers. In a non-limiting example, throttle 116 and brake 118 may be configured to operate in the same manner as similar controls on a motorcycle, where throttle 116 comprises a handle that turns radially such that when the operator turns the handle in a clockwise direction the fuel feed to the power plant increases in direct proportion to the increasing arc of the motion away from the zero point of throttle 116 and increasing the output of power plant 106. Similarly, when the operator turns throttle 116 in a counterclockwise direction to decrease the arc of motion back toward the zero point of throttle 116, the fuel feed to power plant 106 decreases in direct proportion and decreases the output of power plant 106. The increase and decrease of fuel to power plant 106 will increase or decrease the rotational speed of propeller 108, providing the operator with the thrust and control to achieve flight, perform aerobatics during flight, and land without having to change from the prone position within cockpit area 110. Additionally, brake 118 can provide the operator with the ability to engage or disengage brakes (not shown) installed on the landing gear (not shown) to slow, stop, or release the airframe when on the ground.

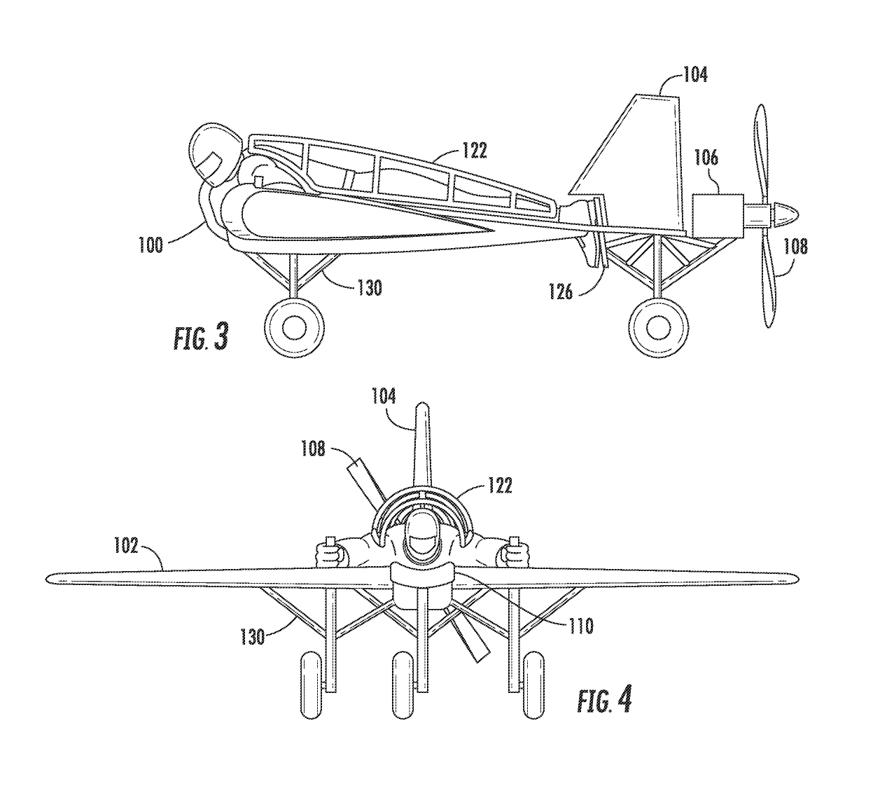

In this exemplary embodiment, cockpit area 110 has a configurable number of movable pads 120 that may be installed within cockpit area 110 and arm extension wells 112, 114 to provide for the comfort of the operator when lying prone in cockpit area 110 during flight operations. The operator is further secured in cockpit area 110 by, for example, in some embodiments, roll cage 122 that opens to allow the operator to enter cockpit area 110 and then closes and latches into place over cockpit area 110 prior to flight operations. Roll cage 122 can be made of high strength yet lightweight materials that provide greater integration with airframe 100 and provides a securing mechanism for the operator during aerobatic maneuvers, such as rolls and banks. A means for additionally securing the operator during operation, in exemplary embodiments, four-point harness 124, can be attached to airframe 100 and extend over the operator when s/he is lying prone in cockpit area 110. Four-point harness 124 is described further in association with FIG. 2.

Referring once again to FIG. 1, tail section 104 includes a rudder and tail flap control surfaces (not shown) disposed in an operational configuration for the operator to control the rudder and tail flap control surfaces using their feet to manipulate tail section controls 126 and control the tail flap control surfaces. Power plant 106 and propeller 108 disposed aft of cockpit area 110 and tail section 104 so as to form a pusher style propulsion system provides the propulsive force to enable the flying apparatus to both take off to perform flight operations, and provide the force required for aerobatic maneuvers desired by the operator when in flight. All sections of the flying apparatus are connected to airframe 100 in a structural integrity that is sufficient to handle the stress and strain both of takeoff and landing operations and aerobatic maneuvers as necessary. An all-terrain fixed landing gear assembly attached to the underside of the airframe (not shown) supports the weight of the flying apparatus and operator when on the ground. The construction of airframe 100 is of suitable materials and strength to maintain the integrity of the flying apparatus during flight and aerobatic maneuvers as performed by the operator.

Additionally, a battery used to power throttle 116 and brake 118 and to provide any necessary electrical stimulus for the operation of power plant 106 can be located, in some embodiments, on the underside of airframe 100. In a non-limiting example, the battery (not shown) can be located at the mid-section portion of airframe 100 below the operator so as to help maintain the balance of the flying apparatus.

Referring now to FIG. 2, a representative view of an operator fastened within cockpit area 110 of certain embodiments of the presently disclosed flying apparatus is presented. In an exemplary embodiment, the operator will lie prone in cockpit area 110 of airframe 100, inserting each arm into extension wells 112, 114 so as to reach the controls installed within extension wells 112, 114. To provide a secure placement within cockpit area 110, four-part harness 124 can be placed across the upper and lower body of the operator and securely fastened. Four-point harness 124 is fastened directly to airframe 100 at the distal ends of the harness straps and the proximal ends of the straps are closed together over the body of the operator using a fastening, such as, in a non-limiting example, one or more locking type connectors. In a non-limiting example the straps of four-part harness 124 may be constructed from leather, reinforced nylon, or any other material having suitable strength to withstand the forces of the operator's body movement during flight and aerobatic operations. The straps of four-point harness 124 are of sufficient length and positioned so as to ensure minimal movement of the operator during such flight and aerobatic operations when the straps of the harness are securely locked into place.

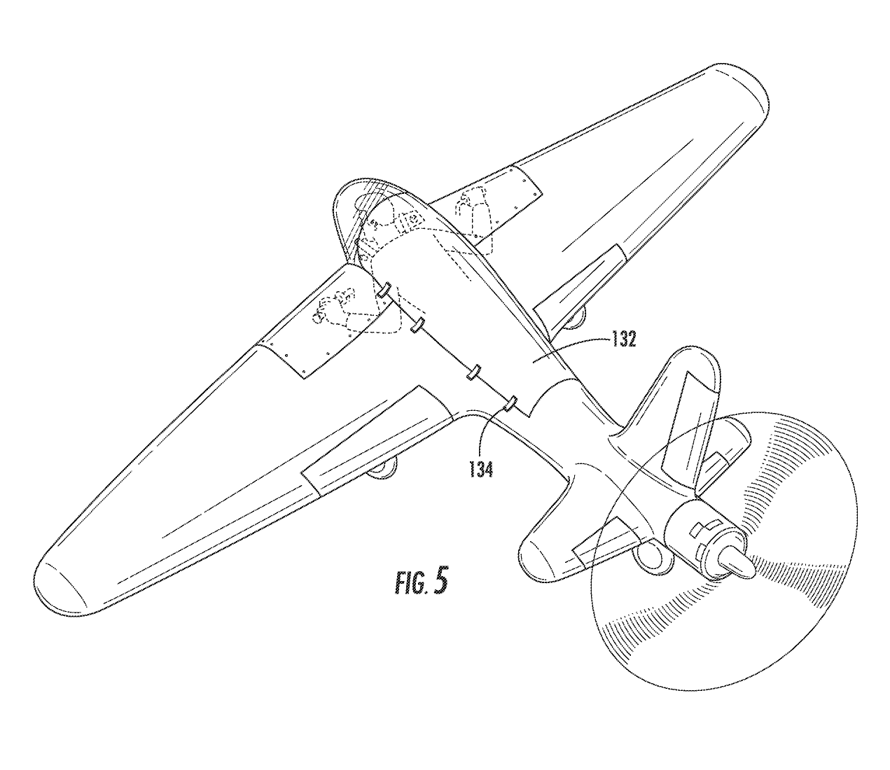

Referring now to FIG. 3, a representative side view of certain embodiments of the presently disclosed flying apparatus with an operator in place and cockpit cover closed is presented. In this exemplary embodiment, the airframe 100 is presented from the side with an operator lying prone in the cockpit 110 with the roll cage 122 closed over the operator to secure the operator within the cockpit 110. With the roll cage 122 closed over the operator the airframe 100 presents a more streamlined profile, as can be seen in this exemplary figure, integrating the operator with the airframe 100 and presenting a configuration similar to a large bird. The tail section 104 extends well above the prone operator to provide lateral stability during flight operations. The power plant 106 is engaged and controlled by the operator to feed power to the propeller 108 when the operator desires to take off, land, or perform aerobatic maneuvers once airborne. While on the ground, the airframe 100 rests on the fixed all-terrain landing gear 130 assembly. The landing gear 130 assembly is composed of a front wheel and two back wheels forming three points of a tripod to provide stability for the airframe 100 to which the landing gear 130 is attached. The wheels of the landing gear 130 are attached through shock absorbing mechanisms so as to absorb the shock of uneven terrain during takeoff and landing operations. When the airframe 100 is engaged in flight operations, the operator will control rudder and tail flap surfaces of the horizontal portion of the tail section 104 through the use of controls 126 manipulated by the operator's feet. This configuration permits the operator to fully experience the thrill and fun of what it must be like to fly in a similar manner as a bird.

Referring now to FIG. 4, a representative front view of certain embodiments of the presently disclosed flying apparatus with an operator in place and cockpit cover closed is presented. This exemplary view presents an example of the airframe 100 and the operator during powered flight. Wing section 102 is presented as it will be maintained during level flight. Tail section 104 and propeller 108 are controlled by the operator's hand controls, throttle 116, brake 118, and wing flaps, and foot controls, to manipulate the rudder and flap flight surfaces, to provide the operator with the ability to perform aerobatic maneuvers during flight. Roll cage 122 is shown securely fastened in place over the operator and cockpit area 110 to provide greater security for the operator and assist in the streamlining of the laminar flow of air over airframe 100. Landing gear 130 are shown fixed in place with a single wheel set beneath the front portion of airframe 100 directly under the front portion of cockpit area 110. One of ordinary skill in the art would recognize that other configurations of landing gear would be suitable for use with the presently disclosed flying apparatus. In this non-limiting example, the operator's arms are inserted in the extension wells to either side of cockpit area 110 providing a lower profile for the operator so as to present lessened wind resistance and provide the operator with the simulated feeling of spreading wings, much like a bird. Although not shown, airframe 100 may be painted in bright colors so as to provide for ease of identification both on the ground and in the air for a particular flying apparatus.

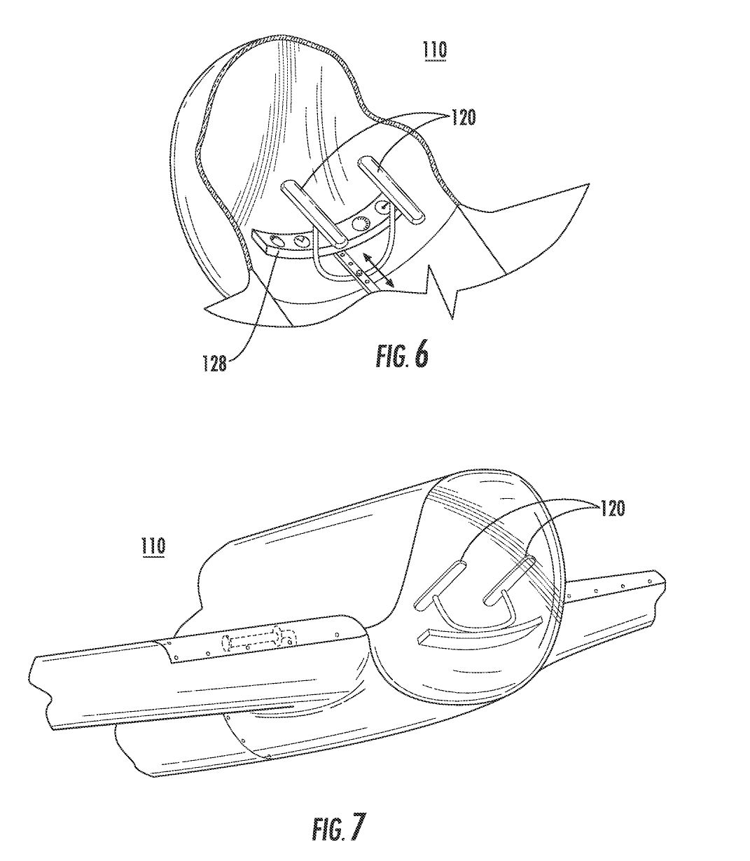

Referring now to FIG. 5, a representative front view of certain embodiments of the presently disclosed flying apparatus with an operator in place and a fully enclosed cockpit is presented. In such embodiments, the cockpit can be enclosed with hatch 132, which is operationally connected to airframe 100 by one or more hinges 134.

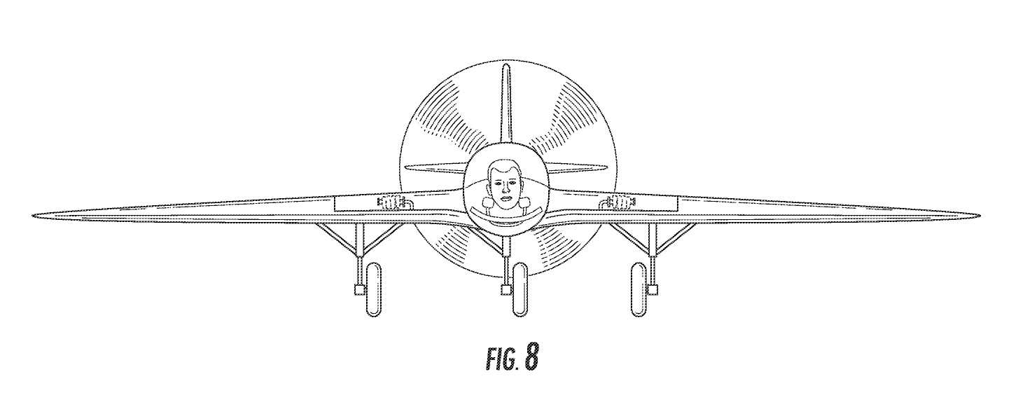

Referring now to FIG. 6, a representative expanded top down view of an enclosed cockpit is presented. Cockpit area 110 can include one or more movable pads 120, the position of which can be adjusted depending on the size and comfort requirements of the operator. Cockpit area 110 also can include one or more gauges 128 for aiding in flying and navigating the flying apparatus. A representative expanded front view of an enclosed cockpit is presented in FIG. 7.

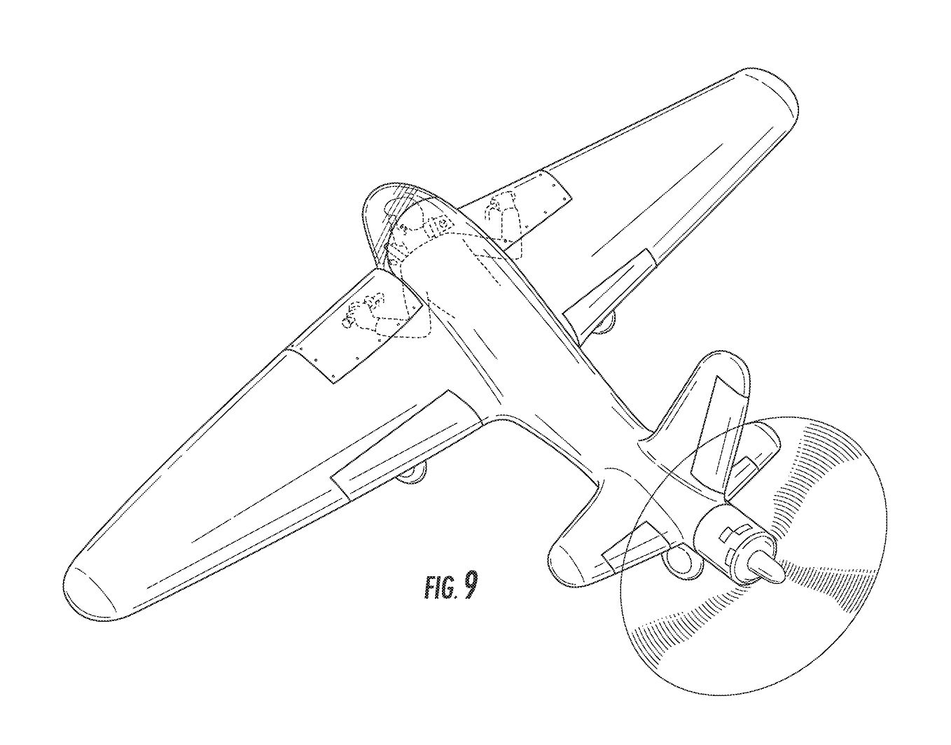

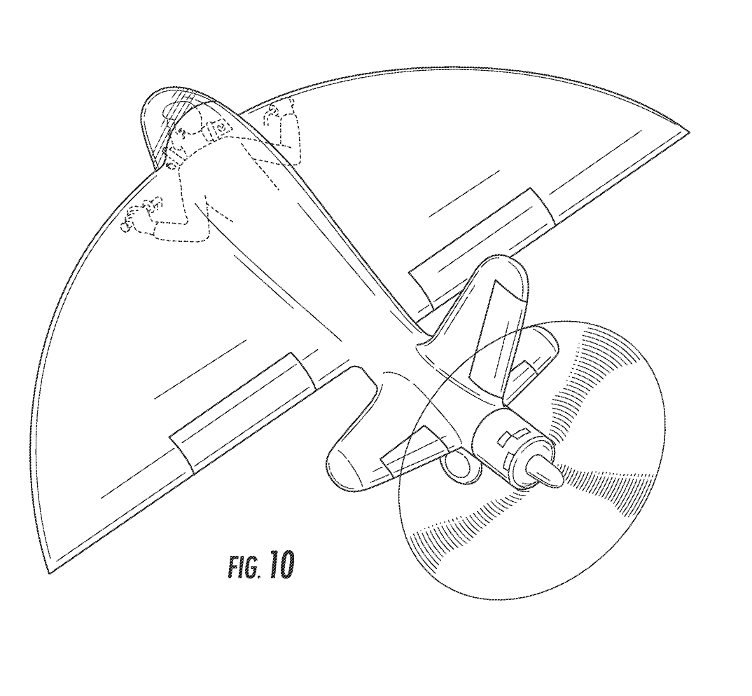

Further embodiments of the presently disclosed flying apparatus are provided in FIG. 8-FIG. 10. More particularly, FIG. 8 provides a front view of the presently disclosed flying apparatus with an operator in place and an enclosed cockpit. FIG. 9 illustrates a top down view of the presently disclosed flying apparatus with an operator in place and an enclosed cockpit. FIG. 10 illustrates a top down view of another embodiment of the presently disclosed flying apparatus with an operator in place and an enclosed cockpit.

The presently disclosed flying apparatus is sufficient, through a combination of configuring an operator in a prone position, providing the capability of manipulating wing and power controls when prone, and fastening the operator in a secure and integrated fashion to the airframe cockpit, to present an operator with the fun and exhilarating experience of “flying like a bird.”

Although specific terms are employed herein, they are used in a generic and descriptive sense only and not for purposes of limitation. Unless otherwise defined, all technical and scientific terms used herein have the same meaning as commonly understood by one of ordinary skill in the art to which this presently described subject matter belongs.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. Although the foregoing subject matter has been described in some detail by way of illustration and example for purposes of clarity of understanding, it will be understood by those skilled in the art that certain changes and modifications can be practiced within the scope of the appended claims.

That which is claimed:

1. An flying apparatus for performing flight operations under control of a human operator, comprising:
an airframe forming the body of the flying apparatus;
a wing section having wing flap flight control surfaces;
a tail section having rudder and tail flap flight control surfaces;
a power plant and propeller sufficient to power the flying apparatus for all flight operations;
a landing gear assembly supporting the airframe when not in flight;
a cockpit and cockpit well extensions sufficient to permit a human operator to operate the flying apparatus in a prone position; and
flying surface controls, power plant controls, and steering controls installed and configured to be manipulated when a human operator is in a prone position.

2. The apparatus of claim 1, where flight operations comprise take off, landing, and aerobatic maneuvers of the flying apparatus as directed by the human operator.

3. The apparatus of claim 1, where the landing gear assembly is an all-terrain assembly comprising a front tire, two rear tires, and being permanently affixed to the underside of the airframe.

4. The apparatus of claim 1, where the power plant further comprises a battery.

5. The apparatus of claim 1, where the cockpit well extensions extend from the cockpit in a lateral configuration sufficient to permit a human operator to comfortably place an arm approximately perpendicular to both the right and left sides of the torso.

6. The apparatus of claim 1, where the rudder and tail flap flight control surfaces are configured to be operated by the feet of a human operator.

7. The apparatus of claim 1, further comprising a harness configured to securely maintain a human operator within the cockpit and cockpit well extensions during flight operations.

8. The apparatus of claim 7, where the harness comprises a four-point strap harness attached at the distal end of each strap directly to the airframe and connected over the human operator by one or more locking connectors integrated into the proximal ends of the straps.

9. The apparatus of claim 1, further comprising a roll cage configured to securely maintain a human operator within the cockpit and cockpit well extensions during flight operations.

10. The apparatus of claim 1, further comprising an enclosed cockpit configured to securely maintain a human operator within the cockpit and cockpit well extensions during flight operations.

11. The apparatus of claim 10, further comprising a hatch for enclosing the cockpit.

12. The apparatus of claim 11, further comprising one or more hinges for operationally connecting the hatch to the air frame.

13. The apparatus of claim 1, where the power plant controls further comprise a throttle and a brake configured to be operated by the hands of the human operator.
